(19) United States
(12) Patent Application Publication
(10) Pub. No.: US 2020/0159333 A1
(43) Pub. Date: May 21, 2020

(54) AUTOMOBILE DASHCAM SYSTEM AND METHOD FOR CONTROLLING STORAGE OF IMAGE

(71) Applicant: JJ CORP, Ansan-si (KR)

(72) Inventors: Jin Woo SHIN, Seongnam-si (KR); Hyun Taek LEE, Gwangmyeong-si (KR); Sang Won EUM, Pyeongtaek-si (KR)

(21) Appl. No.: 16/618,566

(22) PCT Filed: Apr. 27, 2018
(86) PCT No.: PCT/KR2018/004890

§ 371 Date: Dec. 2, 2019

(30) Foreign Application Priority Data
Jun. 15, 2017 (KR) 10-2017-0075592

(51) Int. Cl. G06F 3/01; G06F 3/03; G01J 5/08; G07C 5/08

(52) U.S. Cl. CPC G06F 3/017; G07C 5/0833; G01J 5/0853; G06F 3/0304

(57) ABSTRACT

Provided is an automobile dashcam and a method therefor, and more particularly, to an automobile dashcam system capable of controlling storage of image by simple motion of a user, without directly inputting a command, and a method therefor.

### CROSS-REFERENCE TO RELATED APPLICATIONS

This application is a national entry of PCT Application No. PCT/KR2018/004890 filed on Apr. 27, 2018, which claims priority to and the benefit of Korean Application No. 10-2017-0075592 filed on Jun. 15, 2017, in the Korean Patent Office, the entire contents of which are incorporated herein by reference.

### TECHNICAL FIELD

The present invention relates to an automobile dashcam system and a method therefor, and more particularly, to an automobile dashcam system capable of controlling storage of image by simple motion of a user, without directly inputting a command, and a method therefor.

### BACKGROUND ART

In general, an automobile dashcam system continuously records the view while a vehicle is in use. In the case where a driver wants to start an emergency recording function of the dashcam system, if necessary, while the vehicle is in use, the driver should inconveniently look for an emergency recoding button on the dashcam system by himself or herself to manipulate it.

In order to solve the above inconvenience, there are some efforts to allow a driver to easily notice or manipulate an emergency recording button on the dashcam system. However, if the driver moves to manipulate the emergency recording button, there is a problem in that the motion for manipulating the emergency recoding button may cause driver's concentration to hinder while driving. Therefore, measures for solving the above problem are required.

Also, there is another problem in that the conventional automobile dashcam systems are not provided with a function of storing a wanted specific scene among the images which are recording, if necessary, while the vehicle is in use.

### PATENT LITERATURES

Patent Document 1: Korean Laid-Open Patent Publication 10-2004-0033697, published on Apr. 28, 2004, entitled “Radar detector having battery voltage indicator for automobile”
Patent Document 2: Korean Patent Publication 10-1555449, registered on Sep. 17, 2015, entitled “Four-channel dashcam system of large screen display type having video and audio playback function”

### DISCLOSURE

### Technical Problem

Accordingly, the present invention has been made in view of the above-mentioned problems, and one object of the present invention to provide an automobile dashcam system capable of controlling storage of image by simple motion of a user, without directly inputting a command, and a method therefor.

### Technical Solution

To accomplish the above-mentioned object, according to one aspect of the present invention, there is provided an automobile dashcam system comprising: a camera unit for recording image information or picture information of a view around a vehicle; an image processing unit for receiving the image information or the picture information from the camera unit and converting the information into a digital signal to generate digital image information or digital picture information; a continuous image storing unit for receiving the digital image information or the digital picture information from the image processing unit to continuously store the information in real time; an impact sensor unit for detecting impact applied from an outside to generate impact information; a motion sensor unit for detecting motion of a user to generate motion information; a control unit for receiving and processing the impact information or the motion information from the impact sensor unit or the motion sensor unit; an event image storing unit for receiving and storing the digital image information and the digital picture information stored in the continuous image storing unit according to the impact information and the motion information; a display unit for displaying the image information and the picture information obtained by the camera unit; an audio unit for generating sound information of the image information obtained by the camera unit; and an input unit for inputting a control command to the control unit.

According to a preferred embodiment of the present invention, the motion sensor unit is configured to detect the motion of the user by use of an infrared human body detecting sensor which detects the motion of the user by infrared rays.

According to a preferred embodiment of the present invention, the motion sensor unit includes a sensor for detecting infrared rays generated from a human body to detect the motion of the user around the dashcam system and generate an infrared signal, an amplifier for amplifying the detected infrared signal, and a comparator for converting the amplified signal into a digital signal.

According to a preferred embodiment of the present invention, the motion sensor unit detects the motion of the user by a proximity sensing photo sensor consisting of a light emitting device and a light receiving device.

According to a preferred embodiment of the present invention, the motion sensor unit includes a pulse generator for generating a pulse of a regular interval to turn on or off an infrared light emitting diode (LED), a current booster for increasing a current applied to the LED to smoothly operate the LED, an LED protector for interrupting the current applied to the LED to protect the LED when the generated pulse is maintained at a high value during a reference time or more, a sensor which is a proximity sensing photo sensor capable of emitting the infrared LED to detect infrared pulse reflected from the user's body and convert it into a voltage, an amplifier for amplifying the voltage outputted from the sensor, and a comparator for converting the amplified signal into a digital signal.

According to a preferred embodiment of the present invention, if the continuous image storing unit reaches a full capacity, the control unit sequentially overwrites the oldest digital image information or the oldest digital picture information by new digital image information or new digital picture information.

According to a preferred embodiment of the present invention, if the control unit receives the impact information from the impact sensor unit, the control unit sends a part of the digital image information, which is stored in the continuous image storing unit immediately before the impact information is received, to the event image storing unit to store it, and stores the digital image information, which is obtained by the camera unit during a predetermined time after the impact information is received, in the event image storing unit.

According to a preferred embodiment of the present invention, the control unit executes any one of a predetermined-time image storing function and a still image storing function according to setting of the user if the control unit receives the motion information from the motion sensor unit.

According to a preferred embodiment of the present invention, in a case where the control unit executes the predetermined-time image storing function according to the setting of the user, if the control unit receives the motion information from the motion sensor unit, the control unit sends a part of the digital image information, which is stored in the continuous image storing unit immediately before the motion information is received, to the event image storing unit to store it, and stores the digital image information, which is obtained by the camera unit during a predetermined time after the motion information is received, in the event image storing unit.

According to a preferred embodiment of the present invention, in a case where the control unit executes the still picture storing function according to the setting of the user, if the control unit receives the motion information from the motion sensor unit, the control unit instructs the camera unit to obtain the picture information and to store it in the event image storing unit.

According to another aspect of the present invention, there is provided a method for controlling storage of an image in an automobile dashcam system through motion recognition, the method comprising: a step (A) of setting a control unit to execute any one of a predetermined-time image storing function and a still image storing function according to motion information; a step (B) of obtaining image information and picture information by a camera; a step (C) of converting the image information and the picture information into digital image information and digital picture information by an image processing unit; a step (D) of storing the digital image information and the digital picture information by a continuous image storing unit; a step (E) of detecting motion of a user and generating motion information according to the detected motion to send it to the control unit, by a motion sensor unit; and a step (F) of processing the motion information by the control unit.

According to a preferred embodiment of the present invention, if the motion sensor unit is an infrared human body detecting sensor, the step (E) includes a step of detecting infrared rays generated from a human body by the infrared human body detecting sensor to detect the motion of the user around the dashcam system and generate an infrared signal, a step of amplifying the detected infrared signal, and a step of converting the amplified signal into a digital signal to generate motion information.

According to a preferred embodiment of the present invention, if the motion sensor unit is a proximity detecting photo sensor, the step (E) includes a step of generating a pulse of a regular interval by a pulse generator to turn on or off an infrared light emitting diode (LED), a step of increasing a current applied to the LED by a current booster to smoothly operate the LED, a step of emitting the infrared LED from the proximity sensing photo sensor to detect infrared pulse reflected from the user's body and convert it into a voltage, a step of amplifying the voltage outputted from the proximity detecting photo sensor, and a step of converting the amplified signal into a digital signal.

According to a preferred embodiment of the present invention, when the generated pulse is maintained at a high value during a reference time or more, the step of increasing the current further includes a step of interrupting the current applied to the LED by an LED protector to protect the LED.

According to a preferred embodiment of the present invention, in the step (F), if the control unit is set with a predetermined-time image storing function, the control unit sends a part of the digital image information, which is stored in the continuous image storing unit immediately before the motion information is received, to an event image storing unit to store it, and then stores the digital image information, which is obtained by the camera unit during a predetermined time after the motion information is received, in the event image storing unit.

According to a preferred embodiment of the present invention, in the step (F), if the control unit is set with a still picture storing function, the control unit instructs the camera unit to obtain the picture information and to store it in an event image storing unit.

### Advantageous Effects

With the above configuration of the automobile dashcam system and the method for controlling the storage of the image in the automobile dashcam system according to the present invention, it is possible to control the storage of the image by simple motion of the user, without directly inputting a command.

### DESCRIPTION OF DRAWINGS

FIG. 1 is a block diagram of an automobile dashcam system according to one embodiment of the present invention;

FIG. 2 is a block diagram of a motion sensor unit according to one embodiment of the present invention;

FIG. 3 is a circuit diagram of the motion sensor unit according to one embodiment of the present invention;

FIG. 4 is a view illustrating one example of an infrared sensor device;

FIG. 5 is a block diagram of a motion sensor unit according to another embodiment of the present invention;

FIG. 6 is a view illustrating the detailed configuration of a proximity sensor;

FIG. 7 is a flowchart illustrating a process of storing an image during a predetermined time through motion recognition according to one embodiment of the present invention; and

FIG. 8 is a flowchart illustrating a process of storing a still image through motion recognition according to one embodiment of the present invention.

### MODE FOR INVENTION

Hereinafter, an embodiment of the present invention is explained in detail in conjunction with the accompanying drawings so that those skilled in the art can easily carry out the present invention. In the following description, like reference numerals are attached to elements identical to those throughout the embodiment, and the description thereof is omitted herein.

The term “connected” used herein is not limited to a case where two members or components are directly connected to each other, but should be construed as including a case where two members or components are indirectly connected to each other. The terms “comprising” and “including” in the discussion directed to the present invention and the claims are used in an open-ended fashion and thus should be interrupted to mean “including”, but not limited thereto.

Preferred embodiments of the present invention will now be described in detail with reference to the accompanying drawings.

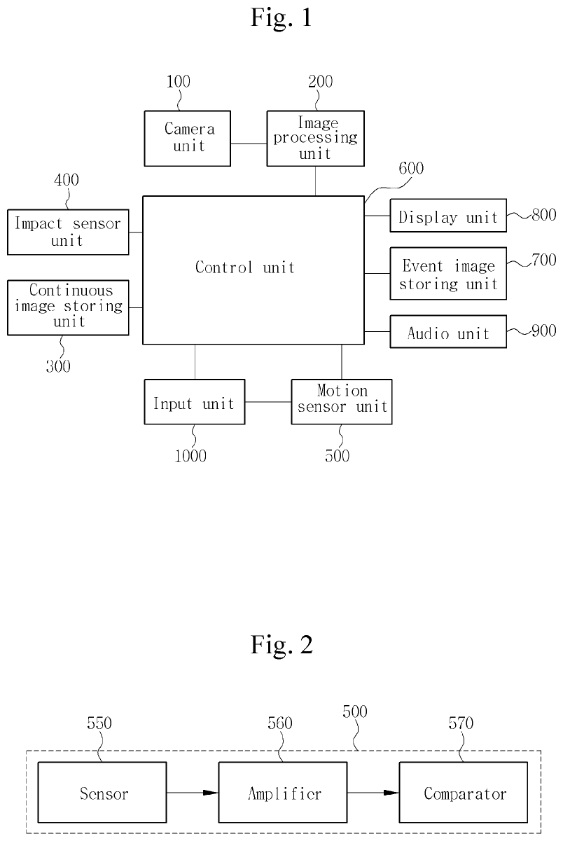

FIG. 1 is a block diagram of an automobile dashcam system according to one embodiment of the present invention. As illustrated in FIG. 1, the automobile dashcam system according to the embodiment includes a camera unit 100 for recording image information or picture information of the view around a vehicle, an image processing unit 200 for receiving the image information or the picture information from the camera unit 100 and converting the information into a digital signal to generate digital image information or digital picture information, a continuous image storing unit 300 for receiving the digital image information or the digital picture information from the image processing unit 200 to continuously store the information in real time, an impact sensor unit 400 for detecting impact applied from an outside to generate impact information, a motion sensor unit 500 for detecting motion of a user to generate motion information, a control unit 600 for receiving and processing the impact information or the motion information from the impact sensor unit 400 or the motion sensor unit 500, an event image storing unit 700 for receiving and storing the digital image information and the digital picture information stored in the continuous image storing unit 300 according to the impact information and the motion information, a display unit 800 for displaying the image information and the picture information obtained by the camera unit 100, an audio unit 900 for generating sound information of the image information obtained by the camera unit 100, and an input unit 1000 for inputting a control command to the control unit 600.

The continuous image storing unit 300 continuously stores the digital image information or the digital picture information obtained by the camera unit 100 while the dashcam system is in use, and if the continuous image storing unit 300 reaches the full capacity, the oldest digital image information or the oldest digital picture information is overwritten by new digital image information or new digital picture information obtained by the camera unit 100.

The impact sensor unit 400 may be an accelerometer or a gyroscope sensor, but the present invention may employ any sensor capable of detecting an impact applied to the vehicle. If the impact sensor unit 400 detects the impact applied to the vehicle to generate and send impact information to the control unit 600. The control unit 600 sends a part of digital image information, which is stored in the continuous image storing unit 300 immediately before the impact information is received, to the event image storing unit 700 to store it, and stores the digital image information, which is obtained by the camera unit 100 during the predetermined time after the impact information is received, in the event image storing unit 700. The part of the digital image information may be varied by setting of a user, and preferably, it may be the digital image information recorded from 15 seconds to 30 seconds immediately before the impact information is received. Also, the set time may be varied by setting of the user, and preferably, it may be a time from 15 second to 30 seconds after the impact information is received.

The control unit 600 can be realized by a computer-readable recording medium using software, hardware or a combination thereof. The control unit 600 including physical hardware arrangement may be realized by any one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and an electric unit for executing some functions. In some cases, embodiments illustrated herein may be implemented by the control unit 600 itself.

The display unit 800 includes at least one of a liquid crystal display, a thin-film transistor-liquid crystal display, an organic light emitting diode, a flexible display, a 3D display. The display unit 800 can display the digital image information or the digital picture information on a screen by dividing the digital image information or the digital picture information into left, right, back and forth regions, or by selecting one of four regions, according to a command outputted from the control unit 600.

The input unit 1000 includes a power button, an emergency recording button, a screen capturing button, a sound button and the like to input a control command into the control unit 600, although not illustrated, and may be one of a key pad, a dome switch, a (capacitive/resistive) touch pad, a jog-shuttle, a switch and a button.

Also, although the dashcam system may include additional components, such as a power unit, a USB and a memory card slot, the additional components are widely known in the field of the automobile dashcam system, and are not illustrated herein.

Hereinafter, embodiments of the motion sensor unit 500 which employs an infrared human body detecting sensor and a proximity sensor, respectively, and a method for controlling the image to be stored in the automobile dashcam system by the motion sensor unit 500 which recognizes motion of the user will be described in detail.

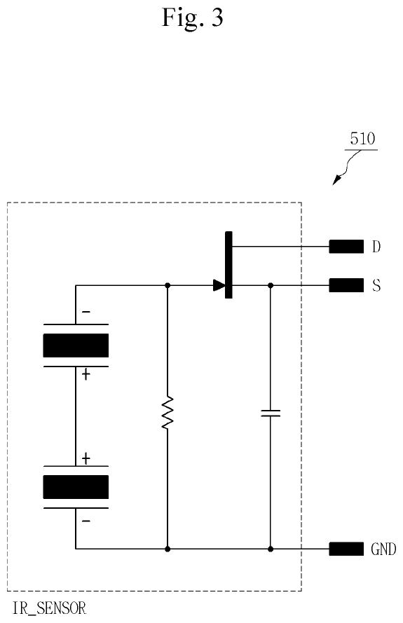

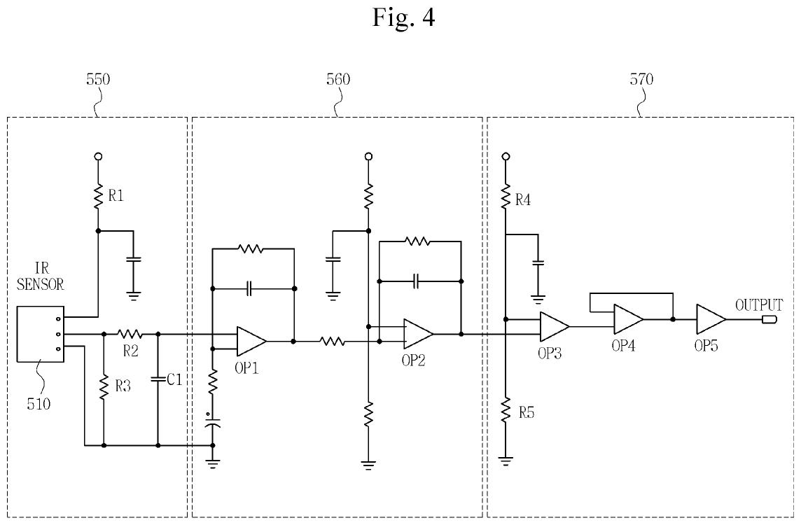

FIG. 2 is a block diagram of the motion sensor unit according to one embodiment of the present invention, and the motion sensor unit employs the infrared human body detecting sensor. The motion sensor unit 500 according to this embodiment includes a sensor 550 which is an infrared sensor device to detect infrared rays generated from a human body. If the sensor 550 detects the motion of the user around the dashcam system to generate a fine sensing voltage. The sensing voltage is amplified by an amplifier 560, and the amplified voltage is applied to a comparator 570 to convert it into a digital signal which is motion information. The motion information is sent to the control unit 600. FIG. 3 is a circuit diagram of the motion sensor unit according to the embodiment of the present invention to show the circuit configuration of sensors 550, 560 and 570 which configure the motion sensor unit 500. As illustrated in FIG. 3, a resistor R1 is configured to set a drain voltage of FET, and resistors R2 and R3 and a capacitor C1 are configured to set a proper time constant while matching an output terminal of the infrared sensor device (IR SENSOR) 510 to an input terminal of a primary amplifier OP1 of the amplifier 560. The motion sensor unit 500 of the present invention is provided with the sensor 550 employing the infrared sensor device. FIG. 4 is an exemplary view showing the infrared sensor element. As illustrated in FIG. 4, the infrared sensor element forms a structure of sending an electrical signal induced in the sensor device 510 to the FET inside thereof and outputting the signal to the outside of the sensor. Resistors R4 and R5 in FIG. 3 provide a reference voltage to an OP amplifier (0P3) of the comparator 570. The comparator 570 compares the reference voltage with the voltage of the signal amplified by a secondary amplifier OP2 and outputs a digital signal of the comparison value which is motion information.

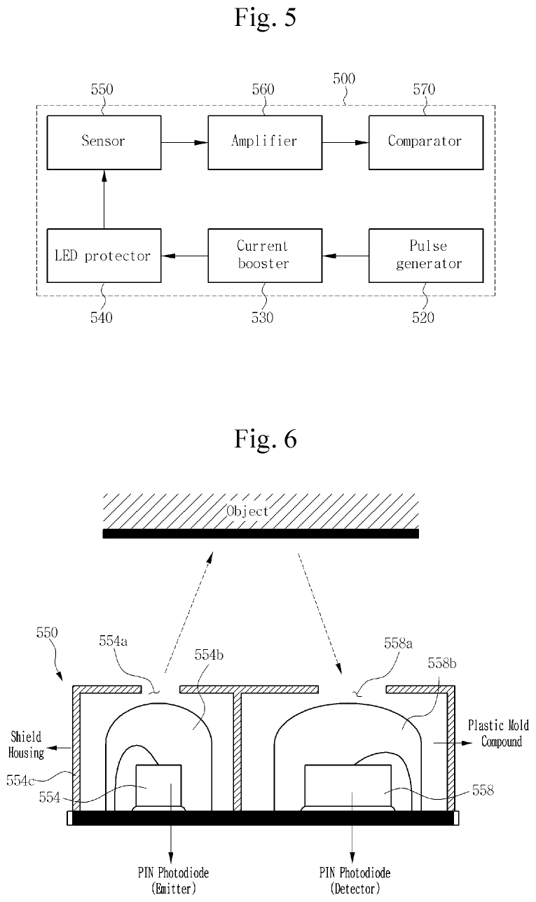

FIG. 5 is a block diagram of a motion sensor unit according to another embodiment of the present invention which employs a proximity sensing photo sensor (hereinafter, referred to as a ‘proximity sensor’) which operates when a human body or an object approaches nearby. As illustrated in FIG. 5, the motion sensor unit 500 according to this embodiment includes a pulse generator 520, a current booster 530, an LED protector 540, a sensor 550, an amplifier 560 and a comparator 570. The pulse generator 520 generates a pulse of a regular interval to turn on or off a light emitting diode (LED). The LED is turned on or off according to a high or low signal of the pulse. The current booster 530 operates the LED by increasing the current applied to the LED for smooth operation of the LED. The LED protector 540 protects the LED from an unnecessarily long pulse width of a high value. If the LED is turned on for a long time, its operating lifespan can be shortened. When the pulse width of a high value is unnecessarily maintained to the LED for a long time, the LED protector 540 turns off the LED by interrupting the current applied to the LED. The sensor 550 is a proximity sensor capable of sensing a user's hand or user's body approaching the dashcam system. The sensor 550 is configured to emit infrared rays toward an object and sense the returned infrared optical pulse reflected from the object, and has an emitter 554 and a detector 558, as illustrated in FIG. 6. FIG. 6 is a view illustrating the detailed configuration of the proximity sensor. As illustrated in FIG. 6, while the emitter 554 and the detector 558 are covered by plastic mold mixtures 554b and 558b, an outside is surrounded by a casing 554c (shield housing). In this instance, the casing 554c has windows 554a and 558a formed on the emitter 554 and the detector 558 to transmit and receive light, respectively. The emitter 554 is an electrical-to-optical converter which emits an infrared optical pulse. The detector 558 detects the IR optical pulse reflected from a shield object, i.e., a hand of a driver, or the surface thereof by use of a PIN optical diode. If the IR optical pulse emitted from the emitter 554 arrives at the shield object or the surface thereof at a detecting distance of about 15 cm from the sensor 550, it is diffracted or reflected toward the detector 558. The detector 558 detecting the optical pulse generates optical current, and converts the optical current into voltage through the resistors to output the voltage. The outputted fine voltage is amplified by the amplifier 560 and then is applied to the comparator 570. The comparator 570 converts the amplified signal into a digital signal, and generates the motion information to send it to the control unit 600.

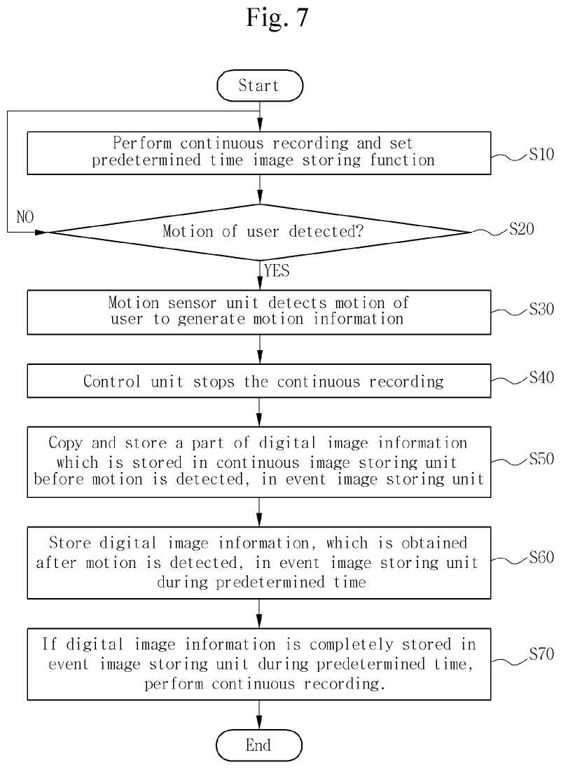

It is possible to control the storage of the image in the dashcam system by the motion information which is generated by the above process and sent to the control unit 600. In order to control the storage of the image in the dashcam system by the motion information, there is needed a previous step in which the control unit 600 has been set in previous to execute any one of a predetermined-time image storing function and a still image storing function according to the motion information. FIG. 7 is a flowchart illustrating a process of storing the image during a predetermined time through motion recognition according to one embodiment of the present invention. As illustrated in FIG. 7, when the user starts the driving of the vehicle, the camera unit 100 performs continuous recording of external environment around the vehicle, and the user sets the control unit 600 to execute the predetermined time image storing function according to the motion information (S10). If the user makes simple motion of his or her hand while driving, the motion sensor unit 500 detects the motion to generate the motion information and send it to the control unit 600 (S20 and S30). The control unit 600 stops the continuous recording of the camera unit 100 (S40). A part of the digital image information which is stored in the continuous image storing unit 300 immediately before the motion information is received is sent to and stored in the event image storing unit 700, and then the digital image information obtained by the camera unit 100 during the predetermined time after the motion information is received is stored in the vent image storing unit 700 (S50 and S60). If the digital image information is completely stored in the event image storing unit 700 during the predetermined time, the control unit 600 controls the camera unit 100 to perform the recording (S70). The expression ‘a part of the digital image information’ means that it may be varied depending upon the user's set, and preferably, it corresponds to the digital image information recorded from 15 second to 30 seconds immediately before the motion information is received. Also, the predetermined time may be varied depending upon the user's set, and preferably, it is a time from 15 second to 30 seconds after the motion information is received.

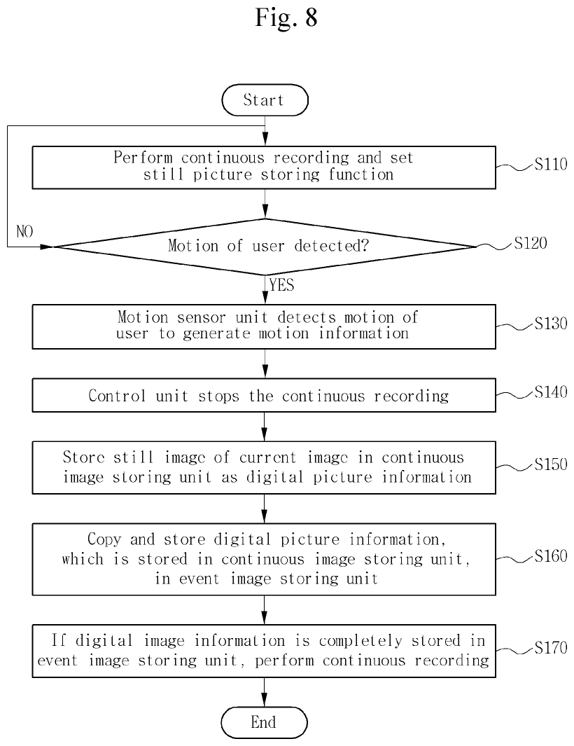

FIG. 8 is a flowchart illustrating a process of storing the still image through motion recognition according to one embodiment of the present invention. As illustrated in FIG. 8, when the user starts the driving, the camera unit 100 performs continuous recording of external environment around the vehicle, and the user sets the control unit 600 to execute the still image storing function according to the motion information (S110). If the user makes simple motion of his or her hand while driving, the motion sensor unit 500 detects the motion to generate the motion information and send it to the control unit 600 (S120 and S130). The control unit 600 stops the continuous recording of the camera unit 100 (S140). The control unit 600 instructs the camera unit 100 to obtain picture information, and then stores it in the continuous image storing unit 300 as digital picture information and stores it in the event image storing unit 700 (S150 and S160). If the digital picture information is completely stored in the event image storing unit 700, the control unit controls the camera unit 100 to perform the continuous recording (S170).

As disclosed in the above embodiments, the user can control the storage of the image in the dashcam system through the simple motion, without directly inputting a command through the input unit 100.

If a communication unit (not illustrated) is added to the automobile dashcam system of the present invention, the user can instruct a service application for managing the dashcam system which is installed in a mobile terminal (not illustrated) of the user, to control the automobile dashcam system, or can verify the digital image information or the digital picture information stored in the continuous image storing unit 300 or the event image storing unit 700 of the automobile dashcam system through the service application. The communication between the mobile terminal (not illustrated) and the automobile dashcam system can employ any one of Bluetooth, radio frequency identification (RFID), infrared data association (IrDA), ultra-wideband (UMB), ZigBee, wireless LAN (WLAN), and Wi-fi. The mobile terminal (not illustrated) may be any one of a cellular phone, a smartphone, a tablet computer, a notebook computer, a digital broadcasting terminal, a personal digital assistants (PDA), and a portable multimedia player (PMP).

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### REFERENCE NUMERALS

100: Camera unit
200: Image processing unit
300: Continuous image storing unit
400: Impact sensor unit
500: Motion sensor unit
520: Pulse generator
530: Current booster
540: LED protector
550: Sensor
560: Amplifier
570: Comparator
600: Control unit
700: Event image storing unit
800: Display unit
900: Audio unit
1000: Input unit

1. An automobile dashcam system comprising:
a camera unit (100) for recording image information or picture information of a view around a vehicle;
an image processing unit (200) for receiving the image information or the picture information from the camera unit (100) and converting the information into a digital signal to generate digital image information or digital picture information;
a continuous image storing unit (300) for receiving the digital image information or the digital picture information from the image processing unit (200) to continuously store the information in real time;
an impact sensor unit (400) for detecting impact applied from an outside to generate impact information;
a motion sensor unit (500) for detecting motion of a user to generate motion information;
a control unit (600) for receiving and processing the impact information or the motion information from the impact sensor unit (400) or the motion sensor unit (500);
an event image storing unit (700) for receiving and storing the digital image information and the digital picture information stored in the continuous image storing unit (300) according to the impact information and the motion information;
a display unit (800) for displaying the image information and the picture information obtained by the camera unit (100);
an audio unit (900) for generating sound information of the image information obtained by the camera unit (100); and
an input unit (1000) for inputting a control command to the control unit (600).

2. The automobile dashcam system according to claim 1, wherein the motion sensor unit (500) is configured to detect the motion of the user by use of an infrared human body detecting sensor which detects the motion of the user by infrared rays.

3. The automobile dashcam system according to claim 2, wherein the motion sensor unit (500) includes
a sensor (550) for detecting infrared rays generated from a human body to detect the motion of the user around the dashcam system and generate an infrared signal,
an amplifier (560) for amplifying the detected infrared signal, and
a comparator (570) for converting the amplified signal into a digital signal.

4. The automobile dashcam system according to claim 1, wherein the motion sensor unit (500) detects the motion of the user by a proximity sensing photo sensor consisting of a light emitting device and a light receiving device.

5. The automobile dashcam system according to claim 4, wherein the motion sensor unit (500) includes
a pulse generator (520) for generating a pulse of a regular interval to turn on or off an infrared light emitting diode (LED),
a current booster (530) for increasing a current applied to the LED to smoothly operate the LED,
an LED protector (540) for interrupting the current applied to the LED to protect the LED when the generated pulse is maintained at a high value during a reference time or more,
a sensor (550) which is a proximity sensing photo sensor capable of emitting the infrared LED to detect infrared pulse reflected from the user's body and convert it into a voltage,
an amplifier (560) for amplifying the voltage outputted from the sensor (550), and
a comparator (570) for converting the amplified signal into a digital signal.

6. The automobile dashcam system according to claim 1, wherein if the continuous image storing unit (300) reaches a full capacity, the control unit (600) sequentially overwrites the oldest digital image information or the oldest digital picture information by new digital image information or new digital picture information.

7. The automobile dashcam system according to claim 1, wherein if the control unit (600) receives the impact information from the impact sensor unit (400), the control unit (600) sends a part of the digital image information, which is stored in the continuous image storing unit (300) immediately before the impact information is received, to the event image storing unit (700) to store it, and stores the digital image information, which is obtained by the camera unit (100) during a predetermined time after the impact information is received, in the event image storing unit (700).

8. The automobile dashcam system according to claim 1, wherein the control unit (600) executes any one of a predetermined-time image storing function and a still image storing function according to setting of the user if the control unit (600) receives the motion information from the motion sensor unit (500).

9. The automobile dashcam system according to claim 8, wherein in a case where the control unit (600) executes the predetermined-time image storing function according to the setting of the user, if the control unit (600) receives the motion information from the motion sensor unit (500), the control unit (600) sends a part of the digital image information, which is stored in the continuous image storing unit (300) immediately before the motion information is received, to the event image storing unit (700) to store it, and stores the digital image information, which is obtained by the camera unit (100) during a predetermined time after the motion information is received, in the event image storing unit (700).

10. The automobile dashcam system according to claim 8, wherein in a case where the control unit (600) executes the still picture storing function according to the setting of the user, if the control unit (600) receives the motion information from the motion sensor unit (500), the control unit (600) instructs the camera unit (100) to obtain the picture information and to store it in the event image storing unit (700).

11. A method for controlling storage of an image in an automobile dashcam system through motion recognition, the method comprising:
a step (A) of setting a control unit (600) to execute any one of a predetermined-time image storing function and a still image storing function according to motion information;
a step (B) of obtaining image information and picture information by a camera (100);
a step (C) of converting the image information and the picture information into digital image information and digital picture information by an image processing unit (200);
a step (D) of storing the digital image information and the digital picture information by a continuous image storing unit (300);
a step (E) of detecting motion of a user and generating motion information according to the detected motion to send it to the control unit, by a motion sensor unit (500); and
a step (F) of processing the motion information by the control unit (600).

12. The method for controlling storage of the image in the automobile dashcam system according to claim 11, wherein if the motion sensor unit (500) is an infrared human body detecting sensor, the step (E) includes
a step of detecting infrared rays generated from a human body by the infrared human body detecting sensor to detect the motion of the user around the dashcam system and generate an infrared signal,
a step of amplifying the detected infrared signal, and
a step of converting the amplified signal into a digital signal to generate motion information.

13. The method for controlling storage of the image in the automobile dashcam system according to claim 11, wherein if the motion sensor unit (500) is a proximity detecting photo sensor, the step (E) includes
a step of generating a pulse of a regular interval by a pulse generator (520) to turn on or off an infrared light emitting diode (LED),
a step of increasing a current applied to the LED by a current booster (530) to smoothly operate the LED,
a step of emitting the infrared LED from the proximity sensing photo sensor to detect infrared pulse reflected from the user's body and convert it into a voltage,
a step of amplifying the voltage outputted from the proximity detecting photo sensor, and
a step of converting the amplified signal into a digital signal.

14. The method for controlling storage of the image in the automobile dashcam system according to claim 13, wherein, when the generated pulse is maintained at a high value during a reference time or more, the step of increasing the current further includes a step of interrupting the current applied to the LED by an LED protector (540) to protect the LED.

15. The method for controlling storage of the image in the automobile dashcam system according to claim 11, wherein in the step (F), if the control unit (600) is set with a predetermined-time image storing function, the control unit (600) sends a part of the digital image information, which is stored in the continuous image storing unit (300) immediately before the motion information is received, to an event image storing unit (700) to store it, and then stores the digital image information, which is obtained by the camera unit (100) during a predetermined time after the motion information is received, in the event image storing unit (700).

16. The method for controlling storage of the image in the automobile dashcam system according to claim 11, wherein in the step (F), if the control unit (600) is set with a still picture storing function, the control unit (600) instructs the camera unit (100) to obtain the picture information and to store it in an event image storing unit (700).
